(19) United States
(12) Patent Application Publication
(10) Pub. No.: US 2009/0095548 A1
(43) Pub. Date: Apr. 16, 2009

(54) DRIVE SYSTEM WITH FLUID PUMP

(75) Inventors: Richard Terrence Tamba, New South Wales (AU); Stephen Tapper, New South Wales (AU); Graham Charles Mowbray, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NT Consulting International Pty Limited, Castle Hill (AU)

(21) Appl. No.: 11/817,222

(22) PCT Filed: Feb. 28, 2006
(86) PCT No.: PCT/AU06/00252

§ 371 Date: May 13, 2008

(30) Foreign Application Priority Data
Feb. 28, 2005 (AU) 2005900937

(51) Int. Cl. B60K 6/20; F16H 3/72; F04B 17/05; F04B 17/03

(52) U.S. Cl. 180/65.21; 475/5; 417/364; 417/410.1; 903/902

(57) ABSTRACT

A drive system (10) including an internal combustion engine (12), a planetary gear-set (16), an electric motor (18) and a transmission (20), wherein the internal combustion engine (12) and the electric motor (18) each drive the transmission (20) via the planetary gear set (16), and the electric motor (18) drives a fluid pump (22) of the transmission (20). In a further embodiment there is disclosed a fluid pump for pumping fluid from a source to a destination, wherein first and second inlet conduits are provided between the source and the pump, first and second outlet conduits are provided between the pump and the destination, and each of the conduits is provided with a valve allowing fluid flow through the conduit in only one direction, such that when the fluid pump is rotated in a first direction fluid is pumped through the first inlet and outlet conduits, and when the fluid pump is rotated in a second opposite direction fluid is pumped though the second inlet and outlet conduits.

### FIELD OF THE INVENTION

This invention relates to a drive system and to a fluid pump.

### BACKGROUND OF THE INVENTION

It has been previously proposed to provide a vehicle with a drive system known as a hybrid drive so that the vehicle is powered by an electric motor as well as by an internal combustion engine. A typical drive system of that kind includes a manual or automatic transmission through which drive is transmitted to driving wheels of the vehicle.

Advantageously, a vehicle having a hybrid drive is able to use a smaller internal combustion engine than a conventional vehicle as additional power is able to be supplied on demand by the electric motor. By using a smaller internal combustion engine, hybrid drive vehicles are able to achieve superior fuel efficiency when compared to conventional vehicles.

In some hybrid drive vehicles, it is possible for the vehicle to accelerate without the use of the internal combustion engine, such that the internal combustion engine is able to be switched off when the vehicle is waiting at traffic lights and/or travelling at low speeds.

An oil pump of an automatic transmission is responsible for producing oil pressure required in the transmission and, in a conventional vehicle, is commonly directly connected to a flange on a torque converter housing. Since the torque converter is directly connected to a crankshaft of the engine, the pump produces pressure whenever the engine is running as long as there is a sufficient amount of oil available. The oil is then sent, under pressure to components of the transmission, such as for lubrication and operation of clutches, as required.

However, in a hybrid drive vehicle, as the internal combustion engine is switched off at times, it is no longer possible for operation of the transmission oil pump to depend on operation of the internal combustion engine. Moreover, oil pressure is still required by the transmission even with the internal combustion engine is switched off, as parts within the transmission require lubrication and hydraulically-actuated clutches may need to be engaged, for example for preventing the vehicle from rolling backwards down inclines.

Some hybrids provide a separate, electric oil pump which is operable independently of the internal combustion engine, however such an additional item adds cost and weight. Weight is often a high priority in the design of fuel-efficient hybrid drive vehicles.

Examples of the invention seek to solve or at least alleviate one or more of the above problems.

### SUMMARY OF THE INVENTION

In accordance with one aspect of the present invention, there is provided a drive system including an internal combustion engine, an electric motor and a transmission, wherein the electric motor drives a fluid pump of the transmission.

Preferably, the drive system includes a planetary gearset, and the internal combustion engine and the electric motor each drive the transmission via the planetary gearset.

Preferably, driving interconnection between the electric motor and the planetary gearset is able to be selectively disconnected via a clutch.

Preferably, the electric motor is located between the planetary gearset and the transmission.

Preferably, the transmission is an automatic transmission.

In accordance with another aspect of the invention, there is provided a drive system including an internal combustion engine, an electric motor and a transmission, wherein a pump of the transmission is arranged to be in driven relationship with the internal combustion engine via a first one-way clutch and is arranged to be in driven relationship with the electric motor via a second one-way clutch, the one-way clutches allowing overrun such that drive to the pump is provided by the internal combustion engine and/or the electric motor according to the relative rotational speeds of the internal combustion engine and the electric motor.

Preferably, both of the one-way clutches allow overrun in the same direction.

More preferably, drive from the internal combustion engine is transmitted by a first shaft, drive from the electric motor is transmitted by a second shaft concentric with the first shaft, and the pump is mounted to rotate concentrically with the first and second shafts.

In accordance with another aspect of the invention, there is provided a drive system including an internal combustion engine, a planetary gearset, an electric motor and a transmission, the internal combustion engine and the electric motor being arranged to drive the transmission via the planetary gearset, and the electric motor being able to rotate in either direction, wherein a bi-directional fluid pump of the transmission is driven by the electric motor.

Preferably, the electric motor is able to operate as a motor and as a generator.

In accordance with another aspect of the invention, there is provided a fluid pump for pumping fluid from a source to a destination, wherein first and second inlet conduits are provided between the source and the pump, first and second outlet conduits are provided between the pump and the destination, and each of the conduits is provided with a valve allowing fluid flow through the conduit in only one direction, such that when the fluid pump is rotated in a first direction fluid is pumped through the first inlet and outlet conduits, and when the fluid pump is rotated in a second opposite direction fluid is pumped through the second inlet and outlet conduits.

Preferably, the valves are ball check type valves. Alternatively, the valves may take other forms.

Preferably, the first outlet conduit is branched from the second inlet conduit and the second outlet conduit is branched from the first inlet conduit.

Preferably, the pump uses an accumulator which maintains pressure of fluid supply to the destination during change in rotational direction of the pump. The accumulator may be in the form of, for example, a cylinder with a piston biased by a spring.

### BRIEF DESCRIPTION OF THE DRAWINGS

The invention is described, by way of non-limiting example only, with reference to the accompanying drawings in which:

FIG. 1 is a diagrammatic representation of a drive system;

FIG. 2 is a diagrammatic representation of a bi-directional pump;

FIG. 3 is a diagrammatic representation of a pump coupled by a pair of one-way clutches to an electric motor and an internal combustion engine;

FIG. 4a is a diagrammatic representation of the pump of FIG. 3 showing operation with input from the electric motor;

FIG. 4b is a diagrammatic representation of the pump of FIGS. 3 and 4a, showing operation with input from the internal combustion engine; and

FIG. 4c is a diagrammatic representation of the pump of FIGS. 3 to 4b, showing operation with input from the electric motor and the internal combustion engine.

### DETAILED DESCRIPTION

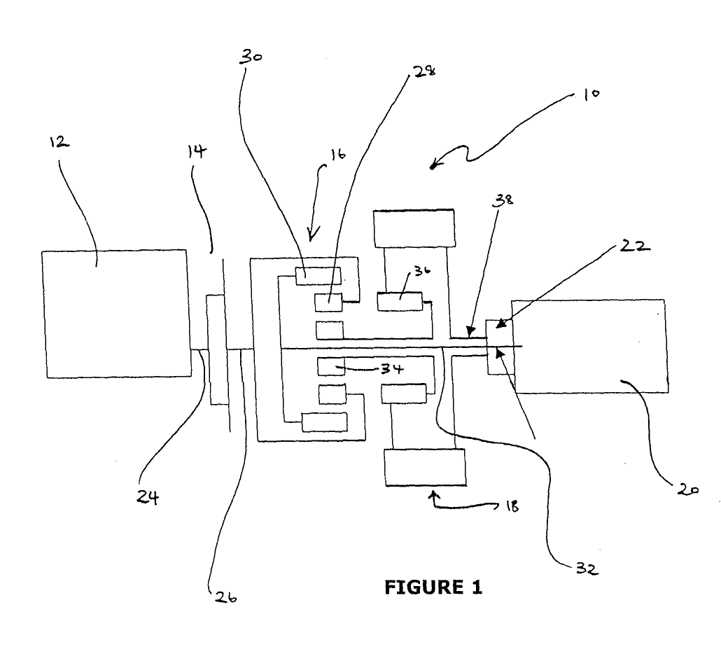

FIG. 1 shows a power flow diagram of an example drive system 10, including an internal combustion engine 12, damper 14, planetary gearset 16, electric motor 18 and automatic transmission 20. The internal combustion engine 12 and the electric motor 18 each drive the automatic transmission 20 via the planetary gearset 16. The electric motor 18 also drives a fluid pump 22 of the automatic transmission 20.

More particularly, in the example shown, the drive system 10 is arranged as a form of parallel hybrid drive wherein the internal combustion engine 12 has a mechanical drive connection to the automatic transmission 20. With reference to FIG. 1, a crank shaft 24 of the internal combustion engine 12 is connected to the damper 14 which serves to dampen pulses arising as a result of the spaced explosions of the internal combustion engine 12. The damper 14 is connected by a shaft 26 to a planet carrier 28 of the planetary gearset 16. A ring gear 30 of the planetary gearset 16 serves as an output of the planetary gearset 16, and transmits drive to the automatic transmission 20 along a drive shaft 32. The automatic transmission 20 then transmits drive to driving wheels of a vehicle in which the drive system 10 is mounted, in a manner generally known in the art.

The electric motor 18 is coupled to a sun gear 34 of the planetary gearset 16 via a clutch 36 which enables the sun gear 34 to be selectively engaged/disengaged from the electric motor 18 so that drive from the electric motor 18 can be obtained when needed. Also, the electric motor 18 is able to be operated as a generator whereby it is driven by the internal combustion engine 12 via the planetary gearset 16 and clutch 36 so as to provide charging to a battery (not shown) used for powering the electric motor 18.

The pump 22 of the automatic transmission 20 provides the automatic transmission with a pressurised source of transmission fluid for lubrication of components of the automatic transmission 20 and also for operation of a hydraulic system which operates clutches and bands within the transmission 20. The electric motor 18 is used to drive the pump 22, so that the pump 22 can be operated independently of the internal combustion engine 12 and, in particular, when the internal combustion engine 12 is switched off. The internal combustion engine 12 may be switched off when not required for drive of the vehicle, for example, at traffic lights and/or when travelling at slow speeds. Drive is transmitted from the electric motor 18 to the pump 22 via shaft 38.

The electric motor 18 can rotate in a first direction, and also in a second, opposite direction. The electric motor 18 operates as a motor when rotating in the first direction, and can operate as a generator in either the first or second directions, depending on relative movement between its generating parts.

In a first example, the transmission pump 22 is driven by only the electric motor 18, and not by the internal combustion engine 12. As the electric motor 18 may rotate in either direction, the pump 22 is adapted so as to be bi-directional. Accordingly, the pump 22 provides a pressurised source of fluid to the transmission 20 whether the electric motor 18 is rotating in the first direction or the second direction.

As the pump 22 is able to rotate in opposite directions, there is a period in which the pump 22 is stationary when changing direction. In this period, the pump 22 does not provide fluid at pressure to the transmission 20. Accordingly, the pump 22 may be used with an accumulator (not shown) which serves as a reservoir of pressurised fluid, able to be relied upon as a source of pressurised fluid during the transition between change in direction of the pump 22. The accumulator may be in the form of an expandable fluid chamber, such as a cylinder with a spring-loaded piston.

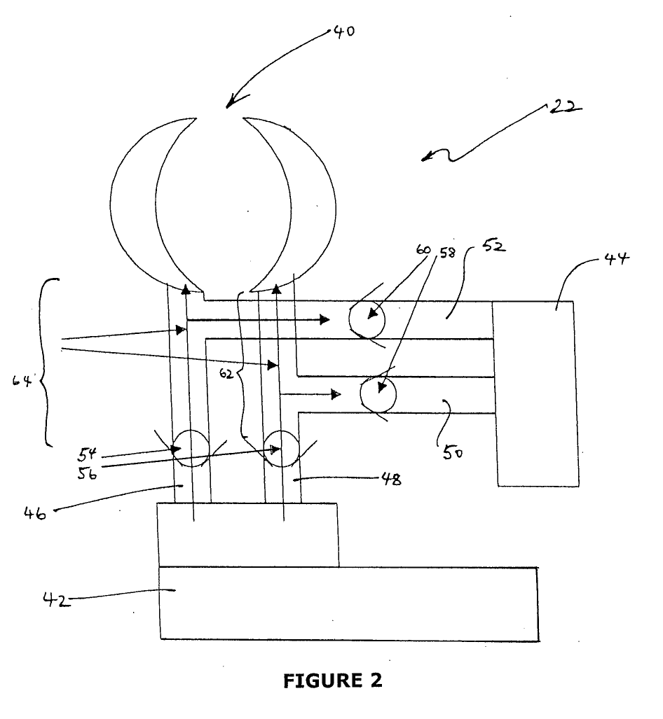

FIG. 2 shows a bi-directional fluid pump 22 which is suitable for use in the drive system 10 of the first example. The pump 22 incorporates a pump component 40, a fluid source 42 in the form of a transmission filter/sump, and a fluid destination 44 in the form of a primary regulator valve which regulates the pressure of fluid supplied to the transmission 20. The pump component 40 may be in the form of a crescent pump, as shown diagrammatically, or an alternative type of pump such as a gerotor or vane type pump. A first inlet conduit 46 and a second inlet conduit 48 are provided between the fluid source 42 and the pump component 40. A first outlet conduit 50 and a second outlet conduit 52 are provided between the pump component 40 and the fluid destination 44. Each of the conduits 46, 48, 50, 52 is provided with a valve 54, 56, 58, 60 which allows fluid flow through the respective conduit in only one direction.

Accordingly, when the pump component 40 is rotated in a first direction (eg. clockwise) fluid is pumped from the fluid source 42 through the first inlet 46. Pressure from the fluid moving from the fluid source 42 to the pump component 40 through the first inlet conduit 46 opens the valve 54, which is in the form of a ball check type valve, as shown in FIG. 2. The fluid is output at pressure from the pump component 40 through the first outlet conduit 50 to the fluid destination 44. The first outlet conduit 50 is branched from the second inlet conduit 48 such that the first outlet conduit 50 and second inlet conduit 48 share a common conduit section 62, between the pump component 40 and the ball check valve 56. Pressure from the fluid moving from the pump component 40 to the destination 44 through the conduit section 62 causes the ball check valve 56 to close, such that fluid is not sent back up the second inlet conduit 48 to the fluid source 42. Pressure from fluid in the first outlet conduit 50 causes ball check valve 58 to open to allow flow of fluid to the destination 44. The pressure in the first outlet conduit 50 may also be used to seat the ball check valve 60 to prevent flow of fluid through the second outlet conduit 52.

Conversely, when the pump component 40 is rotating in the opposite direction (ie. anticlockwise), fluid from the fluid source 42 travels to the pump component 40 via second inlet conduit 48. Pressure from movement of the fluid through the second inlet conduit 48 causes the valve 56 to open. The pump component 40 pumps the fluid from the pump component 40 to the destination 44 via the second outlet conduit 52 which shares a common conduit section 64 with the first inlet conduit 46. This common conduit section 64 extends between the pump component 40 and the ball check valve 54. Pressure from the fluid being pumped from the pump component 40 to the destination 44 via the second outlet conduit 52 causes the ball check valve 54 to be seated so as to prevent back flow of fluid to the fluid source 42 via the first inlet conduit 46. This pressure also causes the ball check valve 60 to open to allow flow of fluid to the destination 44 via the second outlet conduit 52, and may be used to seat the ball check valve 58 to prevent back flow into the second inlet conduit 48.

Accordingly, as the pump 22 shown in FIG. 2 is able to pump fluid at pressure with rotation of the pump component 40 in either direction, this pump 22 is suitable for use in the drive system 10 of the first example, for supplying fluid at pressure to the transmission 20 no matter whether the electric motor 18 is rotating in the first or second direction.

In a variation, the first and second outlet conduits 50, 52 may be joined between the ball check valves 58, 60 and the destination 44. A separate connection may also be required between the fluid source 42 and the destination 44 so as to cater for situations where there is excessive pressure.

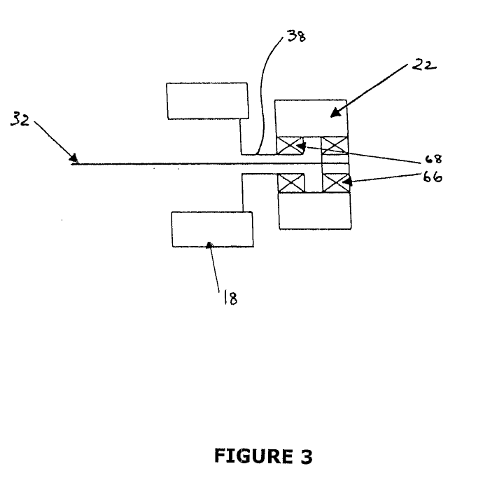

In a second example, the pump 22 is arranged to be driven by both the electric motor 18 and the internal combustion engine 12. FIG. 3 shows an alternative pump configuration which is suitable for use in such an arrangement. The pump 22 is in driven relationship with the internal combustion engine 12 via the drive shaft 32 and a first one-way clutch 66. The pump 22 is also in driven relationship with the electric motor 18 via the shaft 38 and a second one-way clutch 68. The shaft 38 is concentric with and rotates coaxially with the drive shaft 32. Each of the one-way clutches 66, 68 transmits rotation in only one direction and allows overrun in the other direction. More specifically, each of the one-way clutches 66, 68 is arranged to allow overrun in the same direction relative to the pump 22 such that drive to the pump 22 is provided by the internal combustion engine 12 and/or the electric motor 18 according to the rotational velocity of the electric motor 18 relative to the rotational velocity of the internal combustion engine 12. In particular, the pump 22 is driven by whichever of the internal combustion engine 12 and the electric motor 18 is rotating in the driving direction with greater angular velocity.

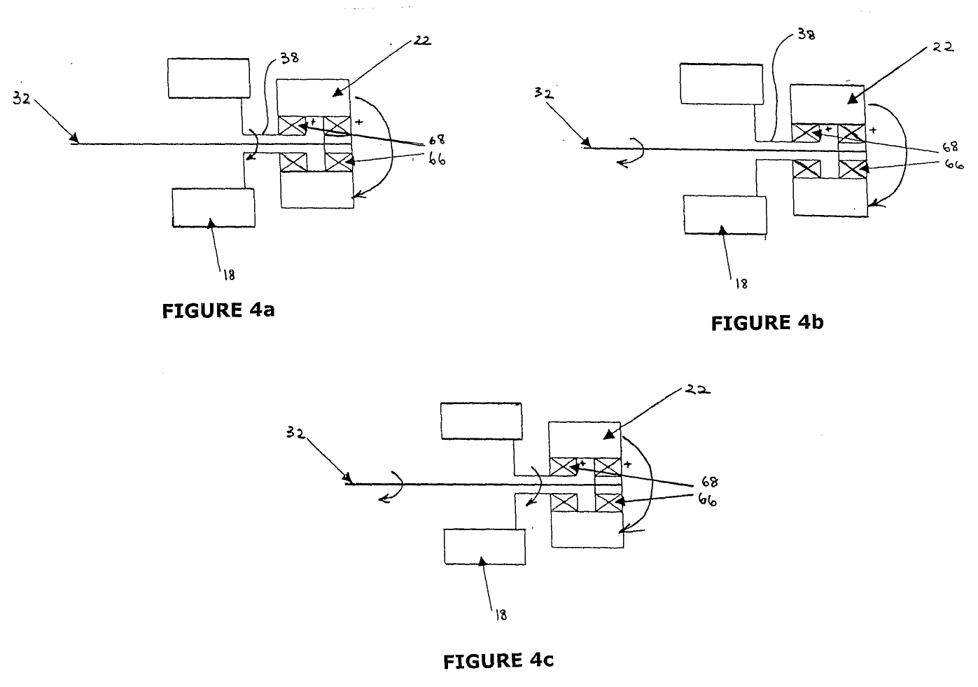

Accordingly, with reference to FIG. 4a, when only the electric motor 18 is rotating in the driving direction, or when the electric motor 18 is rotating at greater velocity in the driving direction than the internal combustion engine 12, drive is transmitted from the electric motor 18 via the shaft 38 and the one-way clutch 68 to the pump 22. In this instance, the one-way clutch 66 allows the pump 22 to rotate relative to the drive shaft 32.

With reference to FIG. 4b, when only the internal combustion engine 12 is rotating in the driving direction, or when the internal combustion engine 12 is rotating with greater angular velocity in the driving direction than the electric motor 18, drive is transmitted from the internal combustion engine 12 via the drive shaft 32 and the one-way clutch 66 to the pump 22. The other one-way clutch 68 allows rotation of the pump 22 relative to the shaft 38 and thus the electric motor 18. Please note that, because of the operation of the one-way clutches 66, 68, in the instance that the internal combustion engine 12 is not operating and the electric motor is rotating in the non-driving direction, no drive will be transmitted to the pump 22. Depending on the route via which rotation of the driving wheels of the vehicle is transmitted to the electric motor 18, this may or may not necessitate alternative means for providing fluid at pressure to the transmission 20 during regenerative braking. The internal combustion engine 12 may be run at idle during generation so as to operate the pump 22.

With reference to FIG. 4c, when both the electric motor 18 and the internal combustion engine 12 are rotating at precisely the same angular velocity, the pump 22 will be driven by both the internal combustion engine 12 via drive shaft 32 and one-way clutch 66, and by the electric motor 18 via shaft 38 and one-way clutch 68.

The above drive system and pump arrangements have been described by way of example only and modifications are possible within the scope of the invention. For example, alternative drive systems may have different “hookup” from the example described and, in particular, different hookup between the internal combustion engine, planetary gearset and electric motor.

1. A drive system including an internal combustion engine, an electric motor and a transmission, wherein the electric motor drives a fluid pump of the transmission.

2. A drive system as claimed in claim 1, wherein the drive system includes a planetary gearset, and wherein the internal combustion engine and the electric motor each drive the transmission via the planetary gearset.

3. A drive system as claimed in claim 2, wherein driving interconnection between the electric motor and the planetary gearset is able to be selectively disconnected via a clutch.

4. A drive system as claimed in claim 2, wherein the electric motor is located between the planetary gearset and the transmission.

5. A drive system as claimed in claim 1, wherein the transmission is an automatic transmission.

6. A drive system including an internal combustion engine, an electric motor and a transmission, wherein a pump of the transmission is arranged to be in driven relationship with the internal combustion engine via a first one-way clutch and is arranged to be in driven relationship with the electric motor via a second one-way clutch, the one-way clutches allowing overrun such that drive to the pump is provided by the internal combustion engine and/or the electric motor according to the relative rotational speeds of the internal combustion engine and the electric motor.

7. A drive system as claimed in claim 6, wherein both of the one-way clutches allow overrun in the same direction.

8. A drive system as claimed in claim 6, wherein drive from the internal combustion engine is transmitted by a first shaft, drive from the electric motor is transmitted by a second shaft concentric with the first shaft, and the pump is mounted to rotate concentrically with the first and second shafts.

9. A drive system including an internal combustion engine, a planetary gearset, an electric motor and a transmission, the internal combustion engine and the electric motor being arranged to drive the transmission via the planetary gearset, and the electric motor being able to rotate in either direction, wherein a bi-directional fluid pump of the transmission is driven by the electric motor.

10. A drive system as claimed in claim 9, wherein the electric motor is able to operate as a motor and as a generator.

11. A fluid pump for pumping fluid from a source to a destination, wherein first and second inlet conduits are provided between the source and the pump, first and second outlet conduits are provided between the pump and the destination, and each of the conduits is provided with a valve allowing fluid flow through the conduit in only one direction, such that when the fluid pump is rotated in a first direction fluid is pumped through the first inlet and outlet conduits, and when the fluid pump is rotated in a second opposite direction fluid is pumped through the second inlet and outlet conduits.

12. A fluid pump as claimed in claim 11, wherein the valves are ball check type valves.

13. A fluid pump as claimed in claim 11, wherein the first outlet conduit is branched from the second inlet conduit and the second outlet conduit is branched from the first inlet conduit.

14. A fluid pump as claimed in claim 11, wherein the pump uses an accumulator which maintains pressure of fluid supply to the destination during change in rotational direction of the pump.

15. A fluid pump as claimed in claim 14, wherein the accumulator is in the form of a cylinder with a piston biased by a spring.
